(19) United States
(12) Patent Application Publication
(10) Pub. No.: US 2021/0170456 A1
(43) Pub. Date: Jun. 10, 2021

(54) DRUM TREATMENT APPARATUS

(71) Applicant: NCH Corporation, Irving, TX (US)

(72) Inventors: Amanda Alsbrook, Dallas, TX (US); Alexander Erdman, Cleveland, OH (US); William Boesch, Marion, MA (US); Michael J. Schuster, Shorewood, IL (US)

(21) Appl. No.: 17/116,371

(22) Filed: Dec. 9, 2020

Related U.S. Application Data
(63) Continuation of application No. 62/946,176, filed on Dec. 10, 2019.

(51) Int. Cl. B08B 9/08; B08B 1/00; B08B 15/04; G01F 23/68

(52) U.S. Cl. CPC B08B 9/0808; B08B 1/005; B08B 1/008; B65D 43/02; G01F 23/683; B08B 9/083; B08B 15/04

(57) ABSTRACT

Disclosed are various embodiments of a drum treatment assembly that is configured to remote waste fluid contained within a drum. In one example, among other, drum treatment assembly includes a drum lid with an aperture and a treatment assembly that is suspended from the aperture in the drum lid. The treatment assembly can include a motor enclosure for a motor and a motor coupler. The treatment assembly can also include a skimmer assembly that is attached to the motor coupler. The skimmer assembly can include a belt system for moving a belt along a longitudinal axis of a drum and a trough. The trough can comprise a belt scraper and a trough aperture, in which the belt scraper is configured to remove waste attached to the belt. The trough aperture is configured to connect to a drainage tube for draining the waste out of the drum.

### CROSS-REFERENCE TO RELATED APPLICATIONS

This application claims priority to and the benefit of co-pending U.S. Patent Application No. 62/946,176, entitled “DRUM TREAMENT APPARATUS, filed on Dec. 10, 2019, the entire contents of which are hereby incorporated herein by reference.

### BACKGROUND

Drum containers are used to store a variety of different materials. Drum containers may be configured to store twenty to sixty gallons of fluids. In some cases, fluids are circulated in and out of the drum containers for different industrial applications. For example, drum containers can be used to store and circulate a washing fluid for pressure washing mechanical components. In this example, the drum container can accumulate waste from circulating the washing fluid. After a certain stage of use, the drum container is sealed and replaced with another drum with new washer fluid.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of a pressure washing apparatus that include a drum treatment assembly, according to one embodiment described herein.

FIG. 1B is a drawing of the drum treatment assembly from FIG. 1A, according to one embodiment described herein.

FIG. 2A is perspective view of a drum top assembly, according to one embodiment described herein.

FIG. 2B is a top view of the drum top assembly from 2A, according to one embodiment described herein.

FIG. 2C is a perspective view of a treatment assembly from FIGS. 2A and 2B, according to one embodiment described herein

FIG. 2D is a cross-sectional view of the treatment assembly from FIG. 2C, according to one embodiment described herein.

FIG. 2E is a perspective view of a tube skimmer, according to one embodiment described herein.

FIG. 3 is a schematic block diagram that provides one example illustration of a control module employed in the drum treatment assembly of FIGS. 1A and 1B, according to various embodiments of the present disclosure.

### DETAILED DESCRIPTION

Disclosed herein are various embodiments of a drum treatment assembly that is configured to remove waste from fluid stored in a drum. In various industrial applications, drum containers are used to store large quantities of fluids. In some use-case scenarios, fluids may be circulated in and out of the drum containers. For example, drum containers can be used to store and circulate a washing fluid for pressure washing mechanical components. In this example, the drum container can accumulate waste from circulating the washing fluid, which is used to clean mechanical components. After a certain stage of use, the accumulated waste impacts the usefulness of the washing fluid and as a result, the washing fluid has to be replaced. At this point, the contaminated washing fluid can be sealed in the drum and another drum of washing fluid can be used as a replacement in order to continue with pressure washing.

Various embodiments of the present disclosure relate to extending the useful life of fluid stored in drum containers. In some aspects, the embodiments involve filtering waste from the fluid in order to extend the useful life of the fluid. In other respects, the embodiments involve performing different treatment operations, such as heating the fluid, monitoring fluid temperature, refilling the drum, and other suitable operations. References will now be made in detail to the description of the embodiments as illustrated in the drawings.

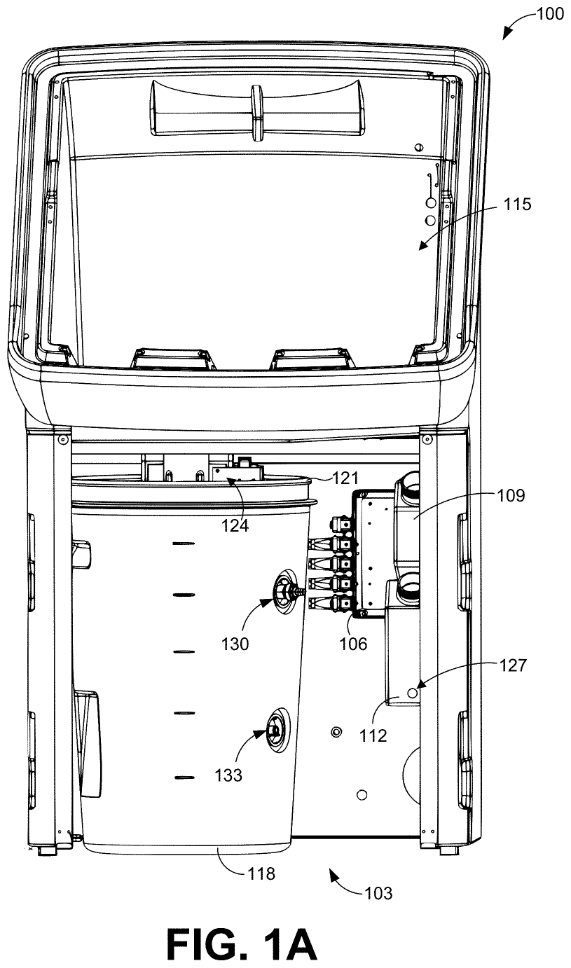

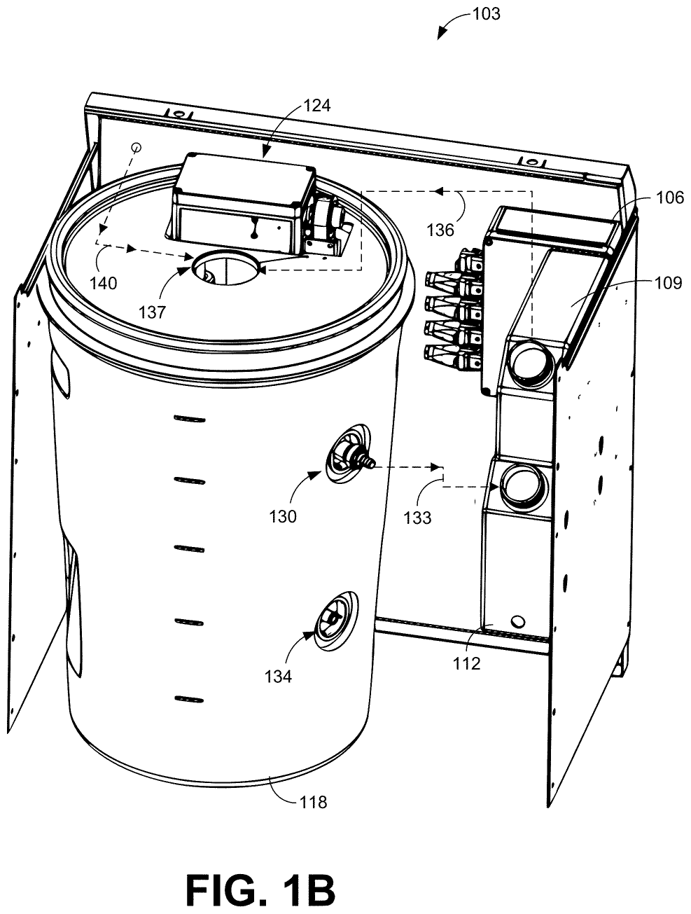

Beginning with FIG. 1A, shown is a drawing of a pressure washing apparatus 100 that can be used for pressure washing mechanical parts. The pressure washing apparatus 100 includes a drum treatment assembly 103, a control module 106, a fluid reservoir 109, a waste reservoir 112, a sink 115, and other components. The pressure washing apparatus 100 is configured to wash mechanical components in the sink 115 with fluid that is circulated by the drum treatment assembly 103. The control module 106 can be used to control the operations of the drum treatment assembly 103.

The drum treatment assembly 103 can include a drum 118, a drum lid 121, and a treatment assembly 124. The drum treatment assembly 103 can be used to circulate fluid stored in the drum 118 and provide the fluid for use in the sink 115. The drum treatment assembly 103 can also be used to remove waste from fluid stored in the drum 118.

The fluid reservoir 109 can be used as an enclosure for storing additional fluid. The additional fluid can be drawn into the drum 118 when the drum 118 is low on fluid. The control module 106 can direct the drum treatment assembly 103 to refill the drum with additional fluid at certain time and under certain conditions.

The waste reservoir 112 can be used as an enclosure for storing the waste filtered from the drum treatment assembly 103. The waste reservoir 112 can include a waste indicator sensor for indicating when contents of the waste reservoir has reached a threshold. The waste reservoir 112 can also include a waste drainage port 127 for draining liquid waste. The waste stored in the waste reservoir can include oil, grease, and other suitable waste.

FIG. 1B illustrates a drum treatment assembly 103 from FIG. 1A with the sink 115 omitted from view. FIG. 1B illustrates that a first drum port 130 can be connected to an exterior drainage tube 133 that connected to the waste reservoir 112. As waste is removed by the drum treatment assembly 103, the waste can travel through the first drum port 130, through the exterior drainage tube 133, and into the waste reservoir 112. In some examples, the waste flows through these components because of gravity.

Further, FIG. 1B illustrates that the drum 118 can be refilled from the fluid reservoir 109 by a fluid tube 136. The control module 106 can detect when the drum 118 is low on fluid. The control module 106 can direct a pump motor to pump fluid from the fluid reservoir 109 and into the drum 118 by way of the fluid tube 136. FIG. 1B also illustrates a second drum port 134 on the side of the drum 118. The second drum port 134 can be used for extracting fluid from the drum 118 and providing it for use, such as in the sink 115. In some examples, the fluid reservoir 109 can contain a chemical solution that is part of a fluid mixture that is used in the drum 118. The fluid mixture can also include water. Water can be added and mixed with the chemical solution. In some embodiments, a water line 140 can be connected to the fluid aperture 137. The water line 140 can have a shut off valve, such as a ball valve, that is electronically controlled by electronics housed in the motor enclosure 206 and/or by the control module 106. Accordingly, the drum 118 can be refilled in part with a chemical solution from the fluid reservoir 109 and in part with water from the water line 140.

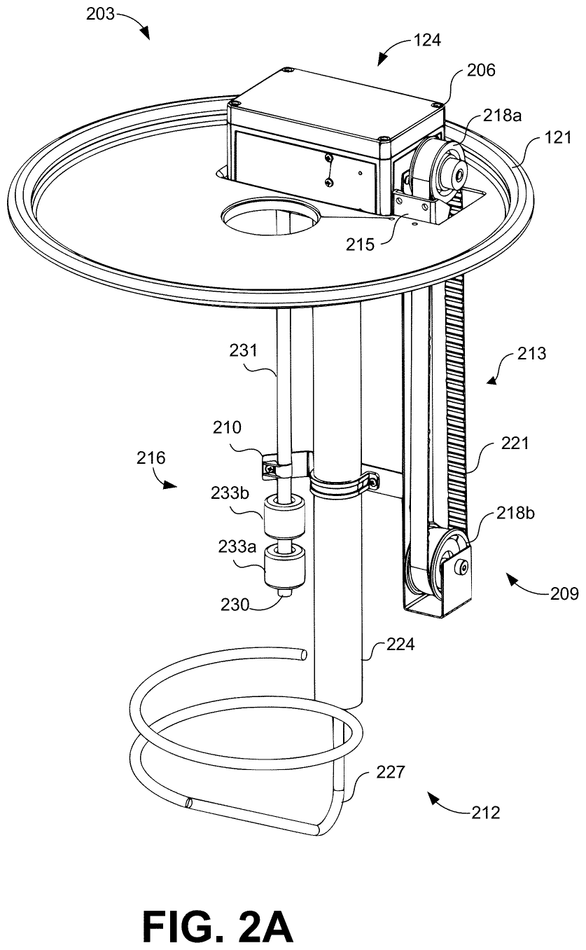

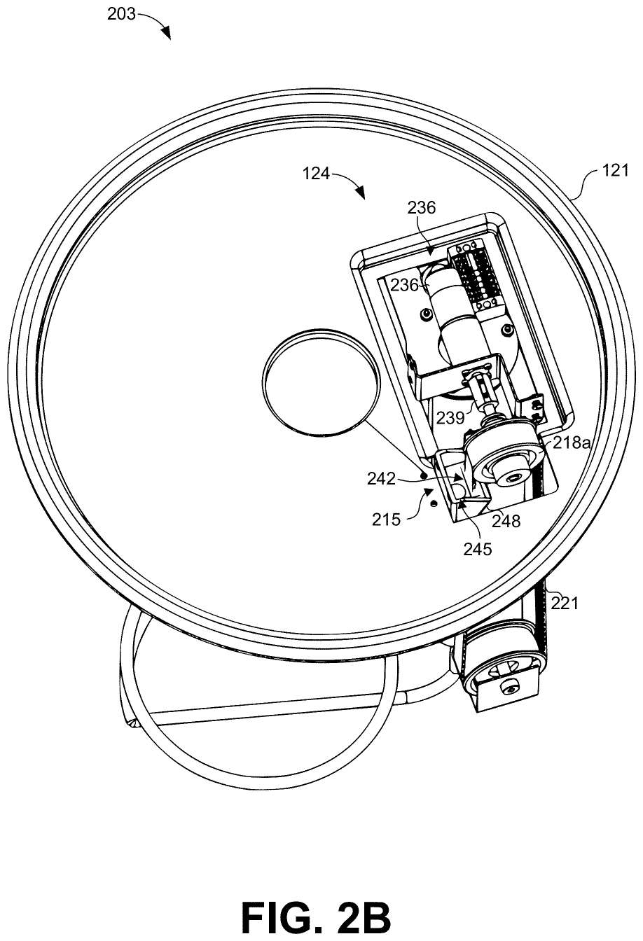

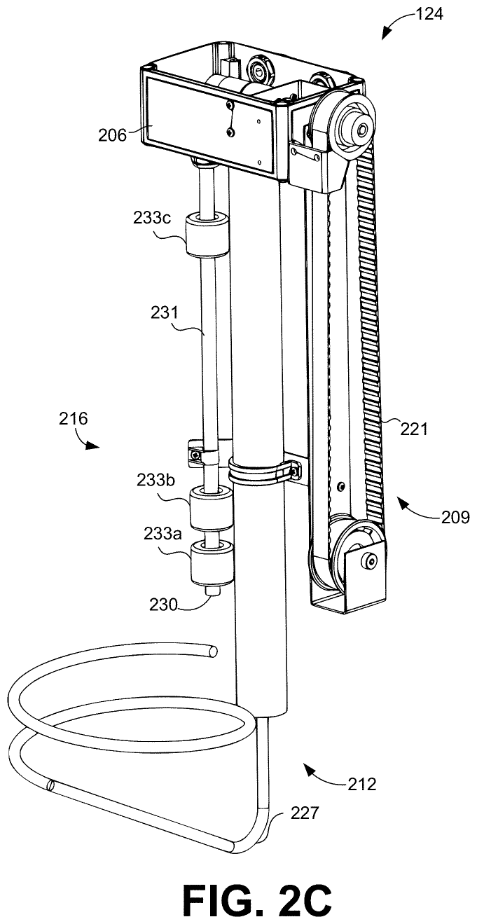

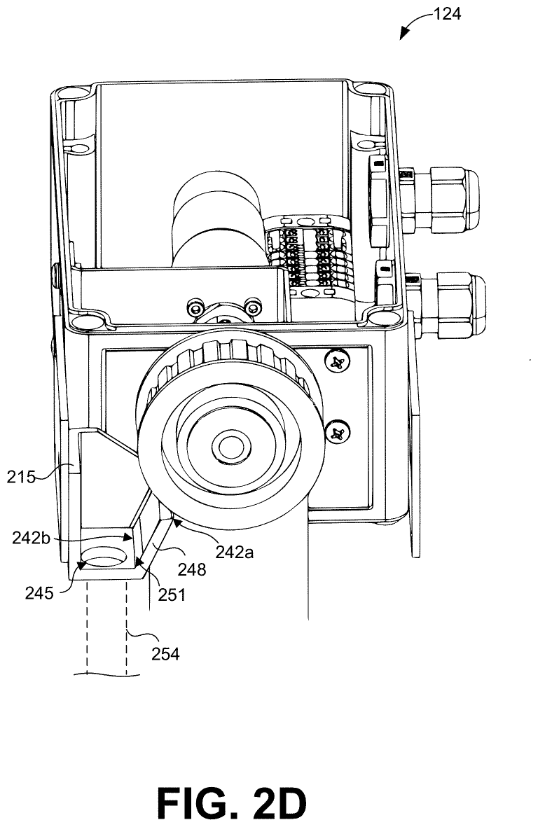

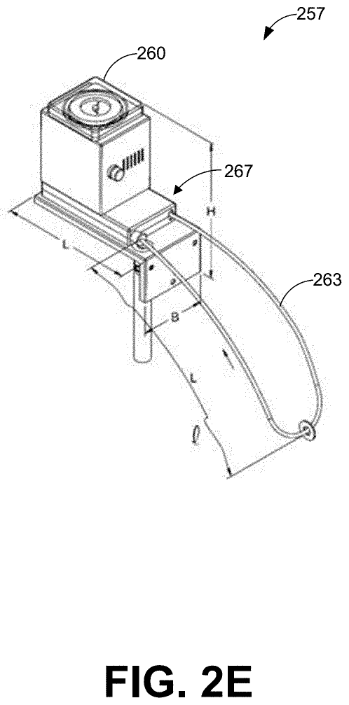

Moving on to FIG. 2A, shown is a perspective view of a drum top assembly 203 from FIG. 1A. The drum top assembly 203 includes the drum lid 121 and the treatment assembly 124. As illustrated, the treatment assembly 124 includes a motor enclosure 206, a skimmer assembly 209, a heating assembly 212, a monitoring system 216, and other suitable components. A cross-bar member 210 can be used to attach the skimmer assembly 210, the monitoring system 215, and the heating assembly 212 to each other.

The motor enclosure 206 can be attached to the skimmer assembly 209, the heating assembly 212, and the monitoring system 216. The motor enclosure 206 can be considered as a gearbox and can be used for housing a motor, a coupler, and other suitable mechanical components. The motor enclosure 206 can also be used to contain other suitable electrical components for operating the motor, the heating assembly 212, the monitoring system 216, and other suitable electrical components. The motor enclosure 206 can be positioned on the drum lid 121. Since the motor enclosure 206 is positioned over an aperture in the drum lid 121, the skimmer assembly 209, the heating assembly 212, and the monitoring system 216 are suspended into the interior of the drum 118.

The skimmer assembly 209 can be used to filter or remove waste that is attached to a belt. The skimmer assembly 209 can include a belt system 213 and a trough 215. The belt system 213 can include a first pulley 218a, a second pulley 218b (collectively “the pulleys 218”), and a belt 221. The belt system 213 rotates the belt 221 between the pulleys 218. An aspect of the belt path includes moving the belt 221 through part of the trough 215. The belt 221 can be used for collecting waste in the fluid stored in the drum 118. The waste can cling to the belt 221 and can be carried around the first pulley 218a. Afterwards, the waste can be deposited into the trough 215. The belt 221 can be comprised of various rubber materials, such as oleophilic materials (e.g., oil-attracting materials), rubber, synthetic and sometive fabric or fiber reinforced materials as can be appreciated, In some embodiments, certain fluids can be used or circulated in the drum 118 in order to increase the tendencies of the waste (e.g. such as oil) to adhere to the belt 221.

The skimmer assembly 209 shown in FIGS. 2A through 2C is one non-limiting example of a skimmer assembly 209 for removing waste from fluids. Further, the components of the belt system 213 can vary. Additionally, the skimmer assembly 209 can be a weir skimmer assembly, a tube skimmer assembly, or other suitable skimmer systems for removing waste from a fluid. For example, a weir skimmer assembly can comprise a dam or enclosure positioned at a surface level of the fluid. Waste, such as oil, grease and other containments, may be floating on the top of the fluid. The waste can spill over an edge of the dam or enclosure and flow into an inner chamber, bringing with the waste very little of the fluid. From the inner chamber, the waste can be channeled to a drainage tube.

The heating assembly 212 can be used to heat fluid stored in the drum 118. The heating assembly 212 can be attached to the motor enclosure 206. The heating assembly 212 can include a support member 224 and a heating element 227. The motor enclosure 206 can be attached to the support member 224, which in turn can be attached to the heating element 227.

The monitoring system 216 can be used to detect the level of fluid in the drum 118 and can be used to determine the temperature of the fluid. The monitoring system 216 can include different combination of sensors used to detect various conditions of the fluid stored in the drum 118. As illustrated in FIG. 2B, the monitoring system 216 includes a temperature sensor 230 for measuring the temperature of the fluid in the drum 118. The temperature sensor 230 can be attached to an end of a rod 231. The control module 106 can use the temperature sensor 230 in combination of the heating element 227 to set the fluid to a particular temperature. The monitoring system 216 can also include a first float sensor 233a, a second float sensor 233b, and a third float sensor 233c (FIG. 2C)(collectively “the float sensor 233”). The first float sensor 233a and the second float sensor 233b can be positioned at different depths within the drum 118. The first float sensor 233a and the second float sensor 233b can be used to detect when a fluid level meets or goes below a certain point.

The float sensors 233 can comprise of a magnetic sensor that closes a circuit when a float lowers to a certain level on the rod 231. The float sensors 233 can be comprised of other types of sensors for detecting a fluid level in a drum 118. Other types of sensors can be used such as rotating, RF electro conductive optical, ultrasonic, mechanical magnetic, hall effect, pneumatic, conductive microprocessor controlled frequency state change, vacuum, vibrating point, capacitance, Optical Interface, microwave, magnetositrictive, Resistive Chain, Magnetoresistive, Hydrostatic pressure, air bubbler, gamma ray.

Turning to FIG. 2B, shown is a top perspective view of the drum top assembly 203 from FIG. 2A. In FIG. 2B, the motor enclosure 206 has been omitted. FIG. 2B illustrates that a motor 237 can be attached to a motor coupler 239, which in turn is connected to the first pulley 218a.

FIG. 2B also illustrates that the trough 215 includes a belt scraper 242 and a trough aperture 245. The belt scraper 242 can be used to scrape waste from the belt 221 and drain the waste through the trough aperture 245. The belt scraper 242 can comprise an edge that makes contact or is situated substantially close to the belt 221. In some non-limiting examples, the edge of the belt scraper 242 can be formed in part from a slot in which the belt 221 extends through. In other non-limiting examples, the belt scraper 242 can be an outer edge of a side surface 248 of the trough 215.

The motor enclosure 206 can be situated in a recessed platform 236. The recessed platform 236 can be lower than a top surface of the drum lid 121. The motor enclosure 206 can be positioned on the recessed platform 236 in order to minimize fluid evaporation. In certain scenarios, the drum top assembly 203 can be used to heat fluid stored in the drum 118 for various reasons to improve fluid performance. By minimizing the holes or apertures in the drum lid 121, the drum top assembly 203 can minimize the amount of evaporation during heating phases.

Turning to FIG. 2C, shown is a perspective view for the treatment assembly 124. In this drawing, the drum lid 121 has been omitted from view. FIG. 2C also illustrates that the monitoring system 216 includes a first float sensor 233a, a second first float sensor 233b, a third float sensor 233c, a temperature sensor 230 (collectively “the float sensors 233), and other suitable monitoring components. Each of the float sensors 233 can transmit a signal to the control module 106 indicating that the fluid in the drum 118 has reached a certain depth. For example, the drum 118 can have a fluid level that is above the third float sensor 233c. The fluid level can lowered over time. As the fluid level lowers below or at the depth of the third float sensor 233c, the third float sensor 233c can physically lower along the rod 231 to open a sensor circuit. Once the sensor circuit is open, the third float sensor 233c can transmit a first signal to the control module 106 that the fluid level is at or below a first depth in the drum 118. Similarly, the second float sensor 233b can transmit a second signal to the control module 106 when the fluid level reaches a second depth in the drum 118, and the third float sensor 233a can transmit a third signal to the control module 106 when the fluid level reaches a third depth in the drum 118. In some examples, fluid level at the second depth may activate a display indicator (e.g., on a visual display or a light indicator) that the fluid level is low in the drum 118. Fluid level at the third depth may active display indicator and cause the control module 106 to shut down the drum treatment assembly 103 (FIG. 1B). The third depth may represent a fluid depth in which the drum treatment assembly 103 does not have sufficient fluid to operate and may cause damage to one or more of the components if operations of the drum treatment assembly 103 continue. Accordingly, the control module 106 can cause the drum treatment assembly 103 to shut down operations in order to prevent damage to the system.

Moving on to FIG. 2D, shown is a cross-sectional view of the treatment assembly 124 from FIG. 2C. In FIG. 2D, the belt 221 is omitted from view and aspects of the trough 215 have been omitted in order to view the interior of the trough 215. In some non-limiting examples, the belt scraper 242a can be an outer edge or an end of the side surface 248. In other words, the outer edge or top portion of the side surface 248 can be used to scrape waste from the belt 221. The belt 221 can be positioned near the outer edge of the side surface 248. Accordingly, as the belt 221 is rotated, it scrapes along the outer edge of the side surface 248.

In another non-limiting example, a belt scraper 242b forms a part of a slot 251 in the side surface 248. The belt scraper 242a can be an edge of the bottom or side surface of the trough 215. The belt 221 can be rotated through the slot 251. As the belt is rotated, the belt 221 is in contact with the belt scraper 242 in order to skim waste off of the belt 221. The removed waste the flows through the trough aperture 245, which is in turn connected to an interior drainage tube 254. The interior drainage tube 254 can be connected to the first drum port 130. In some examples, belt scraper 242a can be used to remove waste and in other cases, belt scraper 242b can be used to remove waste.

Moving on to FIG. 2E, shown is an example of a tube skimmer assembly 257. The tube skimmer assembly 257 can be used as an alternative skimmer system for the treatment assembly 124. The tube skimmer assembly 257 can be suspended from the drum lid 121 or by other aspects of the drum 118. The tube skimmer assembly 257 comprises a motor 260, a tube loop 263, and a tube scraper 267. The exposed portion of the tube loop 263 can be positioned on a surface of the fluid in the drum 118. The motor 260 can be used to rotate the tube loop 263. As such, portions of the tube loop 263 are pulled out of the fluid and portions the tube loop 263 are inserted into the fluid. The portions of the tube loop 263 in the fluid can pick up or attract the waste (e.g., oil). As the tube loop 263 is being rotated, portions of it enter a chamber that includes a tube scraper 267. Within the chamber, the waste is scraped off of the tube loop 263 by the tube scraper 267. The removed waste can then be guided to a drainage tube. The portions of the tube loop 263 that was scraped is then rotated back into the fluid.

Next, a general description of the operations of the drum treatment assembly 103 is provided. In one example, a drum 118 can be filled with fluid such that the fluid level is above the third float sensor 233c. The fluid can be extracted out of the second drum port 134 of the drum. The extracted fluid can be used to wash a mechanical parts on in the sink 115. From the sink 115, the fluid and waste can drain into the fluid aperture 137. Accordingly, the fluid in the drum 118 circulates by being extracted from the drum 118 and being used to wash mechanical parts in the sink 115. Then, the fluid and the waste can then be drained in the drum 118.

The waste may include oil, grease, and other waste related-elements. As the waste accumulates in the drum 118, the control module 106 can activate the belt system 213 to in order to remove the waste from the fluid in the drum 119. Heat helps release oil and can improve skimmer performance. By activating the belt system 213, the belt 221 can circulate a path between the pulleys 218 of the belt system 213. In this example, the second pulley 218b can be submerged in the fluid and the first pulley 218a is situated above the drum lid 121, as depicted in FIGS. 1B, 2A, and 2B. As portions of the belt 221 elevate above the fluid level, waste can attach to the belt 221. Thus, as the belt 221 rotates, waste can be attached to parts of the belt 221 that are emerging from the fluid level.

The attached waste can rotate around the first pulley 218 and can be scraped off of the belt 221 by the belt scraper 242. Waste can accumulate in the trough 215 and flow down through the trough aperture 245. From the trough aperture 245, gravity can cause the waste to flow to a first drum port 130. The first drum port 130 and the trough aperture 245 can be connected by way of an interior drainage tube 254 that is located within the interior of the drum 118. The first drum port 130 can be connected to the waste reservoir 112 by an exterior drainage tube 133. As indicated by the reference arrows for the exterior drainage tube 133, the waste flows into the waste reservoir 112.

The waste reservoir 112 can include a waste sensor that transmit a signal to the control module 106 when the waste reservoir 112 reaches a certain threshold, such as, for example, full, substantially near-full, half-full, or some other suitable level. When a certain level in the waste reservoir 112 has been reached, an operator can access the waste drainage port 127 in order to drain the waste from the waste reservoir 112.

During the operations of the drum treatment assembly 103, the fluid level in the drum 118 can decrease over time. The control module 106 can receive fluid level indicators from the float sensors 233 of the monitoring system 216. When one or more float sensors 233 provide level indicators concerning the fluid level, the control module 106 can instruct a pump to extract fluid from the fluid reservoir 109 and provide the fluid to the drum 118 by way of the fluid tube 136.

Also, during different phases of operations, the drum treatment assembly 103 can use the monitoring system 216 and the heating assembly 212 to elevate the temperature of the fluid to a certain level. In some respects, different fluids may require to be operated at a certain temperature or within 70 f to 130 f or other temperature ranges as can be appreciated. The heating assembly 212 can activate the heating element 227 to elevate the temperature of the fluid. The monitoring system 216 can use the temperature sensor 230 to provide temperature measurements of the fluid. In some scenarios, once the temperature sensor 230 provides a temperature measurement at a certain temperature or within a particular temperature range, then the control module 106 can direct the heating assembly 212 to turn off or lower the temperature of the heating element 227.

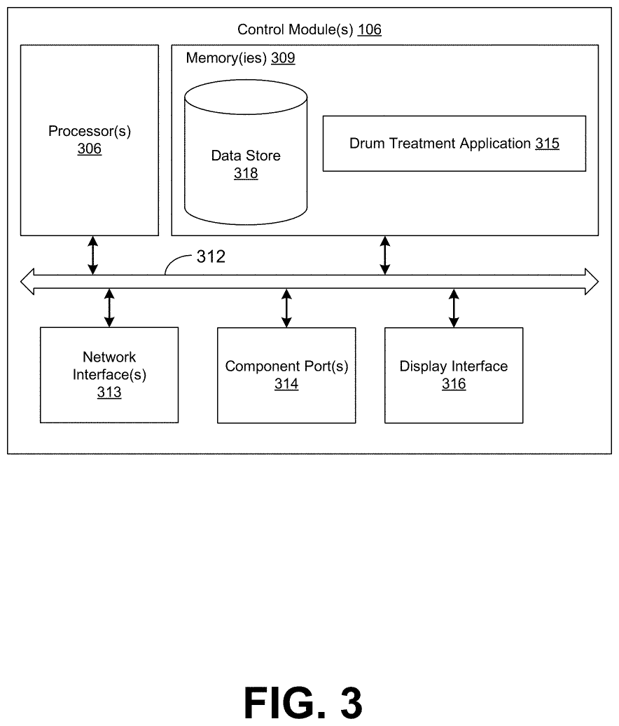

Moving on to FIG. 3, shown is a schematic block diagram of the control module 106 from FIGS. 1A and 1B. The control module 106 can include at least one processor circuit, for example, having a processor 306 and a memory 309, both of which are coupled to a local interface 312. The local interface 312 may comprise, for example, a data bus with an accompanying address/control bus or other bus structure as can be appreciated.

The control module 106 can also include a network interface 313, a component port 314, a display interface 316, and other suitable components. The network interface 313 can include a wired or wireless transceiver, a telemetry module, and other communication components. The network interface 313 can enable the pressure washing apparatus 100 and/or aspects of the drum treatment assembly 103 to access a network for data communication.

The network interface 313 can be used to provide data of the status and usage of the drum treatment assembly 103. For example, the network interface 313 can be used to provide runtime statistics, such as cycle time of operational use, alerts, fluid levels, etc. In some embodiments, the runtime statistics can be used to predict maintenance issues on different components of the drum treatment assembly 103. For example, the control module 106 can determine a certain amount of run-time hours have been accrued for the skimmer assembly 209, the monitoring system 216, or the heating assembly 212. The run-time hours can be used to predict when a component may need to be replaced. For instance, after 2,000 run-time hours, then the skimmer assembly 209 may need to be replaced.

In this instance, the control module 106 can notify a computing device of a sales agent or an operator for the drum 118 that the skimmer assembly 209 or some other aspect of the drum treatment assembly 103 may need to be serviced. In this example, the control module 106 can notify a computing device of a sales agent of a decline or increase of use of the drum treatment assembly 103. The decline or increase in cycle time can be determined based on a history of runtime statistics.

The component ports 314 can include one or more input and/or output ports to different components of the drum treatment assembly 103. For example, the component ports 314 can include plug ports to the monitoring system 216, such as the float sensors 233 and the temperature sensor 230. The components ports 314 can also include plug ports to the heat element 227 and the skimmer assembly 209 for controlling these aspects of the system. The component ports 314 can also a power plug, a pump motor plug, and other suitable components. The display interface 316 can represent circuitry for interface with user displays, light indicators, and other suitable display indicators. For example, the float sensors 233 can activate one of multiple colored light indicators. In this example, a red light indicator can be activated if the first float sensor 233a is activated, and a yellow light indicator can be activated if the second float sensor 233b is activated. In another example, a user display can be used to display the status and/or the usage of the drum treatment assembly 103. The control module 106 can direct the display interface 316 to render statuses such as, operating mode, power on, power off, cycle usage, fluid levels, runtime statistics, and other suitable data.

Stored in the memory 309 are both data and several components that are executable by the processor 306. In particular, stored in the memory 309 and executable by the processor 306 is a drum treatment application 315, and potentially other applications. Also stored in the memory 309 may be a data store 318 and other data. In addition, an operating system may be stored in the memory 309 and executable by the processor 306.

It is understood that there may be other applications that are stored in the memory 309 and are executable by the processor 306 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 309 and are executable by the processor 306. In this respect, the term “executable” means a program file that is in a form that can ultimately be run by the processor 306. Examples of executable programs may be, for example, a compiled program that can be translated into machine code in a format that can be loaded into a random access portion of the memory 309 and run by the processor 306, source code that may be expressed in proper format such as object code that is capable of being loaded into a random access portion of the memory 309 and executed by the processor 306, or source code that may be interpreted by another executable program to generate instructions in a random access portion of the memory 309 to be executed by the processor 306, etc. An executable program may be stored in any portion or component of the memory 309 including, for example, random access memory (RAM), read-only memory (ROM), hard drive, solid-state drive, or other memory components.

The memory 309 is defined herein as including both volatile and nonvolatile memory and data storage components. Volatile components are those that do not retain data values upon loss of power. Nonvolatile components are those that retain data upon a loss of power. Thus, the memory 309 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 306 may represent multiple processors 306 and/or multiple processor cores and the memory 309 may represent multiple memories 309 that operate in parallel processing circuits, respectively. In such a case, the local interface 312 may be an appropriate network that facilitates communication between any two of the multiple processors 306, between any processor 306 and any of the memories 309, or between any two of the memories 309, etc. The local interface 312 may comprise additional systems designed to coordinate this communication, including, for example, performing load balancing. The processor 306 may be of electrical or of some other available construction.

Although the drum treatment application 315, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the drum treatment application 315, that comprises software or code can be embodied in any non-transitory computer-readable medium for use by or in connection with an instruction execution system such as, for example, a processor 306 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the drum treatment application 315, may be implemented and structured in a variety of ways. For example, one or more applications described may be implemented as modules or components of a single application. Further, one or more applications described herein may be executed in shared or separate computing devices or a combination thereof. Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A drum treatment assembly, comprising:
a drum; and
a treatment assembly that is suspended within the drum, the treatment assembly comprising:
a skimmer assembly comprising:
a belt system for moving a belt along a longitudinal axis of the drum; and
a trough that includes a belt scraper and a trough aperture, wherein the belt scraper is configured to remove waste attached to the belt, and the trough aperture is configured to be connected to a drainage tube;
a heating element that extends along the longitudinal axis of the drum; and
a float system that extends the longitudinal axis of the drum, wherein the float system is configured to detect a fluid level in the drum.

2. The drum treatment assembly of claim 1, wherein the float system further comprises:
a first sensor that is positioned a first distance along a rod, wherein the first sensor is configured to detect the fluid level at the first distance; and
a second sensor that is positioned a second distance along the rod, wherein the second sensor is configured to detect the fluid level at the second distance.

3. The drum treatment assembly of claim 1, wherein the treatment assembly further comprises a temperature sensor that is configured to measure a temperature of the fluid in the drum.

4. The drum treatment assembly of claim 1, wherein the trough comprises a side surface that includes the trough aperture, wherein the side surface is angled with respect to a bottom surface of the trough aperture.

5. The drum treatment assembly of claim 1, wherein the belt scraper is formed from an outer edge of the side surface of the trough.

6. The drum treatment assembly of claim 1, wherein the treatment assembly further comprises a motor enclosure that is attached to the skimmer assembly by way of a motor coupler.

7. The drum treatment assembly of claim 1, wherein the treatment assembly is suspended by a drum lid.

8. A drum top assembly, comprising:
a drum; and
a treatment assembly that is suspended within the drum, the treatment assembly comprising:
a motor enclosure that include a motor and a motor coupler; and
a skimmer assembly that is attached to the motor coupler, the skimmer assembly comprising:
a belt system for moving a belt along a longitudinal axis of the drum; and
a trough that includes a belt scraper and a trough aperture, wherein the belt scraper is configured to remove waste attached to the belt, wherein the trough aperture is configured to be connected to a drainage tube for draining the waste out of the drum.

9. The drum top assembly of claim 8, wherein the skimmer assembly further comprises a first pulley attached to the motor coupler and a second pulley spaced away from a drum lid along the longitudinal axis of the drum.

10. The drum top assembly of claim 8, wherein the trough aperture is situated in a bottom surface of the trough.

11. The drum top assembly of claim 8, wherein the belt scraper is an outer edge of a side surface.

12. The drum top assembly of claim 11, wherein the side surface is slanted with respect to a bottom surface of the trough.

13. The drum top assembly of claim 8, further comprising a controller that is data communication with the skimmer assembly, wherein the controller is configured to initiate operation of the skimmer assembly on a periodic interval.

14. The drum top assembly of claim 8, wherein the drainage tube connects to an inner fitting of the drum.

15. The drum top assembly of claim 8, wherein the treatment assembly is suspended by being situated on a recessed platform that extends along a perimeter of the aperture in the drum lid.

16. The drum top assembly of claim 8, wherein the belt scraper is positioned at a height that is between a first pulley and a second pulley of the belt system.

17. A drum top assembly, comprising:
a drum; and
a treatment assembly that is suspended within the drum, the treatment assembly comprising:
a float system that extends along a longitudinal axis of the drum, wherein the float system is configured to detect a fluid level in the drum, wherein the float system comprising:
a first sensor that is positioned at a first depth in the drum, wherein the first sensor is configured to detect the fluid level at the first depth; and
a second sensor that is positioned at a second depth in the drum, wherein the second sensor is configured to detect the fluid level at the second depth.

18. The drum top assembly of claim 17, wherein at least one of the first sensor or the second sensor comprises a magnetic switch that opens or closes based on a movement of a float component.

19. The drum top assembly of claim 17, further comprising a temperature sensor that is configured to detect a temperature of a fluid in the drum.

20. The drum top assembly of claim 17, wherein the float system is in data communication with a controller.

21. The drum top assembly of claim 8, further comprising a controller that is configured to at least:
determine a cycle time of operational use for the treatment assembly; and
transmit a service notification to a remote computing device based at least in part on the cycle time meeting a service threshold.

22. The drum top assembly of claim 8, further comprising a controller that is configured to at least:
determine a cycle time of operational use for the treatment assembly; and
detect a decline in the cycle time based at least in part on a history of cycle time; and
transmit a decline notification to a remote computing in response to detecting the decline in the cycle time.
